(19) United States
(12) Patent Application Publication
(10) Pub. No.: US 2024/0251693 A1
(43) Pub. Date: Aug. 1, 2024

(54) CROP DEBRIS CLEARING SYSTEM

(71) Applicant: YETTER MANUFACTURING COMPANY, Colchester, IL (US)

(72) Inventors: Derek W. ALLENSWORTH, Macomb, IL (US); Derek A. LITCHFIELD, Macomb, IL (US)

(21) Appl. No.: 18/426,582

(22) Filed: Jan. 30, 2024

Related U.S. Application Data
(60) Provisional application No. 63/441,869, filed on Jan. 30, 2023.

(51) Int. Cl. A01B 35/28; A01B 23/02

(52) U.S. Cl. CPC A01B 35/28; A01B 23/02

(57) ABSTRACT

A residue coulter apparatus is configured to cleanly sever and clear crop debris from a planting row, causing minimal disturbance to the soil. The residue coulter apparatus comprises a pair of crop debris clearing discs each having a plurality of back-swept teeth extending about their periphery. The teeth are separated by recesses formed between the teeth. The clearing discs are located on opposite sides of the planter and are angled toward each other so that the leading edges of the clearing discs are pointed in a toe-in orientation. The residue coulter apparatus also includes floater wheels that are coupled to a first side of the crop debris clearing discs. The floater wheels include a series of tines that are configured to be aligned with the teeth of the clearing disc such that there is one tine per tooth of the clearing discs. The floater wheels also include a series of recesses formed between the tines wherein the recesses are aligned with the recesses formed in the clearing discs.

### CROSS REFERENCE TO RELATED APPLICATION

This application claims priority under 35 U.S.C. § 119(e) to U.S. Provisional Application Ser. No. 63/441,869, filed Jan. 30, 2023, which is expressly incorporated herein by reference in its entirety.

### FIELD OF THE INVENTION

This invention relates to crop debris clearing devices and more particularly to a novel and improved arrangement using substantially flat rotatable clearing discs each having a plurality of teeth extending from its periphery that are adapted to completely sever crop residue for easier removal.

### BACKGROUND OF THE INVENTION

By way of background but not limitation, residue coulters typically include a pair of concave discs opposing each other and mounted at conveying angles. The residue coulters are adapted to engage the soil to cut and plow residue out from in front of the planter. Residue coulters typically are overly aggressive and cause extensive soil tillage, reducing the effectiveness of the planter. Extensive soil tillage is undesirable because excessive movement of the soil can increase erosion. The increased use of low-till and no-till farming methods has created the need for apparatus that can be attached to farm implements for clearing debris such as mulch and plant stalks from the field, particularly during planting of a row crop such as corn. In order to facilitate the proper emergence of corn plants the corn seeds are required to be planted at a precise depth and properly spaced. The depth of the planting of the seed is controlled by wheels of the planter unit. The presence of corn stalks or other debris in the row line during the planting operation can change the elevation of the wheels and effect the accuracy of the seeding.

In view of the above, it should be appreciated that there is a need for a residue coulter that cleanly severs and clears crop debris from the planting row while causing minimal disturbance to the soil.

### SUMMARY OF THE INVENTION

In accordance with the present disclosure, a crop debris clearing system is used to more efficiently remove crop debris with minimal soil disturbance.

In illustrated embodiments, a novel and improved residue coulter apparatus is configured to cleanly sever and clear crop debris from a planting row, causing minimal disturbance to the soil. In the preferred embodiment, the residue coulter apparatus comprises a pair of crop debris clearing discs each having a plurality of back-swept teeth extending about their periphery. The teeth include a cutting edge beveled on at least one side and adapted to sever residue from last year's crop. The teeth are separated by recesses formed between the teeth. The clearing discs are oriented substantially vertical to the ground. Two clearing discs are used in combination to clear a pathway for planting seed. The clearing discs are located on opposite sides of the planter and are angled toward each other so that the leading edges of the clearing discs are pointed in a toe-in orientation. The present design effectively removes crop debris and causes minimal soil disturbance.

In illustrative embodiments, the residue coulter apparatus includes floater wheels that are coupled to a first side of the crop debris clearing discs. The floater wheels are tined and include a series of tines that are configured to be aligned with the teeth of the clearing disc such that there is one tine per tooth of the clearing discs. The floater wheels also include a series of recesses formed between the tines wherein the recesses are aligned with the recesses formed in the clearing discs.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a residue coulter showing a frame for supporting a pair of rotating clearing discs and floater wheels coupled to the clearing discs;

FIG. 2 is a top view of FIG. 1 showing the frame and first and second hubs coupled to the frame and the first and second clearing discs and floater wheels coupled to the hubs;

FIG. 3 is a front view of FIG. 1 showing the frame and first and second clearing discs and floater wheels coupled to the frame by use of hubs;

FIG. 4 is side elevational view of FIG. 1 showing the frame and the clearing discs and floater wheels;

FIG. 5 is a top perspective view of FIG. 1;

FIG. 6 is a top perspective view similar to FIG. 2 showing the clearing discs without the floater wheels installed;

FIG. 7 is a front view of FIG. 6 showing the frame and first and second clearing discs coupled to the frame by use of hubs;

FIG. 8 is a front elevational view of FIG. 6 showing the frame and the clearing discs;

FIG. 9 is a top view of FIG. 6;

FIG. 10 is a side elevational view of one of the clearing discs;

FIG. 11 is a top view of the clearing disc of FIG. 10;

FIG. 12 is a front elevational view of one of the floater wheels:

FIG. 13 is a side elevational view of FIG. 12;

FIG. 14 is an exploded perspective view of one of the clearing discs showing the disc positioned between a set of fasteners and a hub and also showing first and second guard members used to cover the teeth of the clearing disc;

FIG. 15 is an exploded perspective view showing one of the floater wheels, one of the clearing discs and one of the hubs;

FIG. 16 is a front elevational view of the floater wheel and clearing disc with first and second guard members positioned over the teeth of the clearing disc;

FIG. 17 is a perspective view of a pair of clearing discs coupled to the frame;

FIG. 18 is a perspective view of one of the floater wheels;

FIG. 19 is another perspective view of the floater wheel of claim 18 showing the rear side of the floater wheel;

FIG. 20 is another perspective view of the floater wheel of claim 19.

### DETAILED DESCRIPTION

While the present disclosure will be described hereinafter with reference to the accompanying drawings, in which a particular embodiment is shown, it is to be understood at the outset that persons skilled in the art may modify the disclosure herein described while still achieving the desired result. Accordingly, the description that follows is to be understood as a broad informative disclosure directed to persons skilled in the appropriate art and not as limitations on the present disclosure.

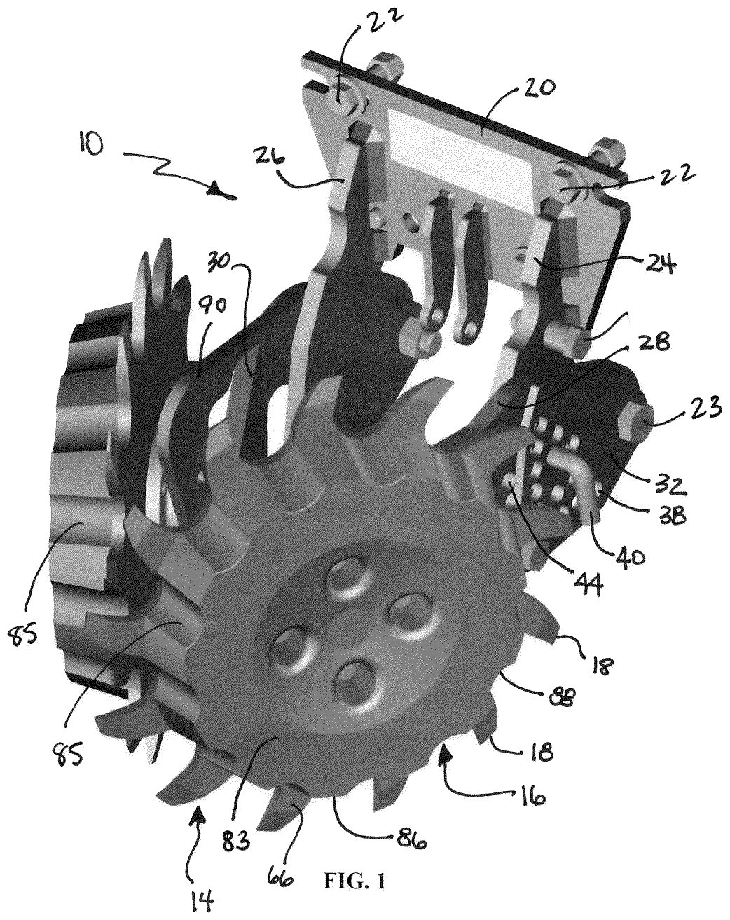

As illustrated in the drawings, FIG. 1 illustrates a residue coulter 10 connected in front of a crop planter (not shown) in accordance with the present disclosure. The entire arrangement can be connected to a tool bar, which, in turn, is connected to a tractor (not shown). The residue coulter 10 of the present invention provides effective residue removal from the planting row while causing minimal soil disturbance and reduces plugging, clogging, and soil build up on clearing discs 14. The residue coulter 10 also provides for superior soil depth control by permitting clearing discs 14 to be positioned closer to gauge wheels.

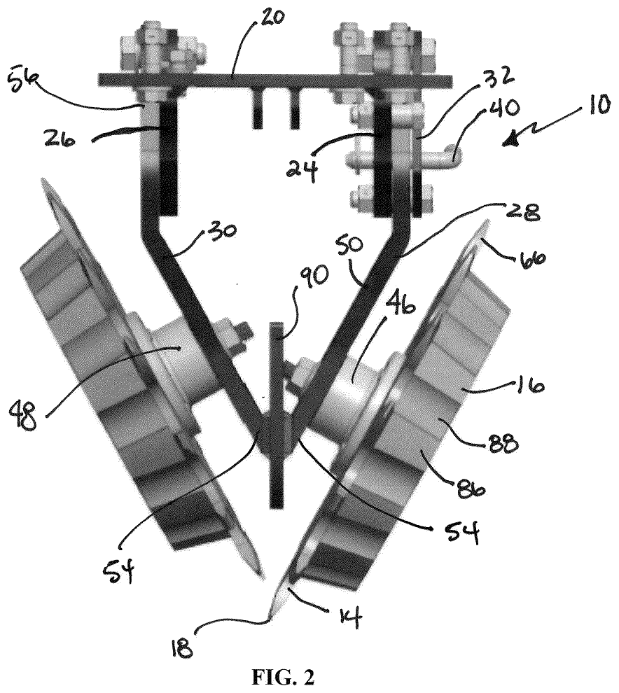

The clearing discs 14 used with the residue coulter 10 of the present invention completely sever crop residue with minimal soil disruption. The clearing discs 14 of the residue coulter 10, as shown in FIGS. 1 and 2, are operated in a substantially vertical orientation with respect to the ground and provide desirable residue removal with the least occurrence of soil engagement. The clearing discs can be used alone or in combination with floater wheels 16 that are coupled to a first side 18 of the clearing discs 14. Floater wheels 16 are configured to rotate with clearing discs 14 when pulled behind the tractor.

The clearing discs 14 further include sharp cutting edges 18 that completely sever hard to remove residue such as BT corn hybrids, and bio-tech corn hybrids, such as rootworm resistant corn. The residue coulter 10 is connected to the leading edge of the planter 12 by use of a mounting plate 20. It should be understood that farm implements may have many planters 12 for simultaneously planting many rows of crops. The configuration of the mounting plate 20 used to attach the residue coulter 10 to the planter varies depending upon the make and model of the planter. Bolts 22 can be used to secure the mounting plate 20 to the front of the planter. Connected to the mounting plate 20 are a pair of outwardly extending first and second brackets 24, 26 that are connected to the mounting plate 20 by use of bolts 23, as shown in FIG. 1. Connected to the first and second brackets 24, 26 are a pair of inwardly inclined first and second arms 28, 30. Residue coulter 10 also includes first and second outer brackets 32, 34, which are located outwardly of first and second arms 28, 30. The first and second brackets 24, 26 in combination with the first and second arms 28, 30, first and second outer brackets 32, 34 and mounting plate 20 form a support frame 36.

The first and second outer brackets 32, 34 may each include a plurality of apertures 38 that are adapted to accept a lock pin 40, as shown in FIGS. 1 and 2. The first and second arms 28, 30 also include a plurality of apertures 42 that are adapted to accept the pin 40. Likewise, the first and second brackets 24, 26 may each include a plurality of apertures 44 that are adapted to accept pin 40. While one pin 40 is shown, it is contemplated that two pins can be used on each arm 28, 30. Alignment of the apertures 38 of the first and second outer brackets 32, 34 with the apertures 42 of the first and second arms 28, 30 and apertures 44 of the first and second brackets 24, 26 permit the installation of the pin 40. The pin 40 retains the first and second arms 28, 30 to the first and second brackets 24, 26 and first and second outer brackets 32, 34. Repositioning the pin 40 permits variable adjustment of the position of the clearing discs 14 and floater wheels 16 with respect to the planter. The apertures 38, 42, 44 permit vertical and horizontal adjustment of the clearing discs 14 and floater wheels 16 to control soil contact.

The first and second brackets 24, 26 in combination with the first and second arms 28, 30 and the first and second outer brackets 32, 34, permit forward, rearward, and vertical adjustment of the bracket arrangement.

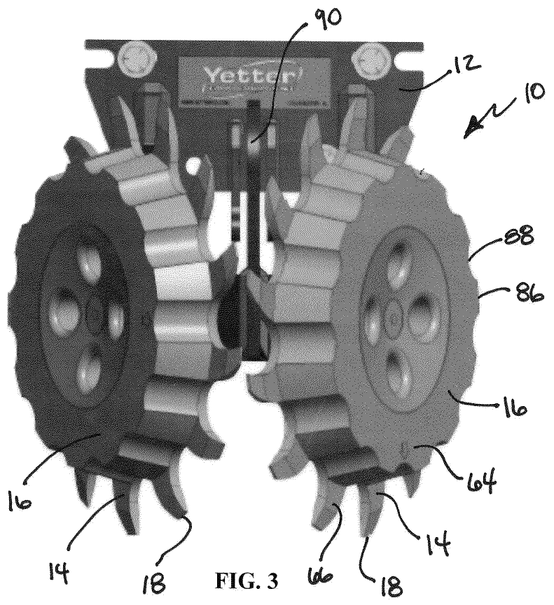

The clearing discs 14, as shown in FIG. 3, are rotatably connected at the leading end of the first and second arms 28, 30, as shown in FIGS. 1-4. The clearing discs 14 are journaled for rotation utilizing first and second hubs 46, 48 that includes internal bearings and are attached to axles utilizing a construction known to those skilled in the art. The clearing discs 14 are positioned in a substantially vertical orientation, with a deviation from vertical from about 8 degrees to about 10 degrees. The slight pitch of the clearing discs 14 permit sufficient removal of debris from the planting row. The use of a modest clearing disc pitch results in significantly less disturbance of the soil and reduces the distance the debris is removed from the planting row.

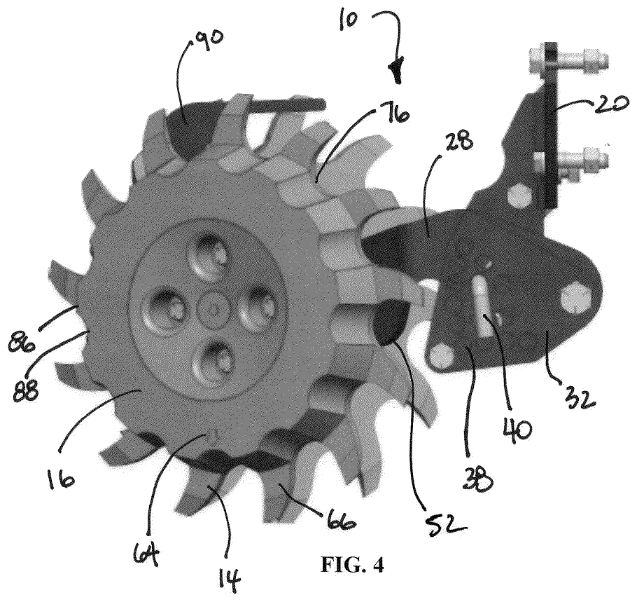

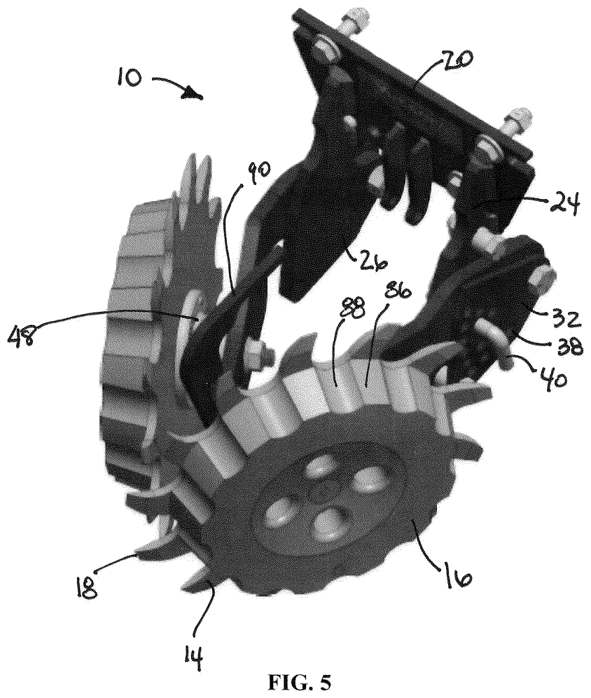

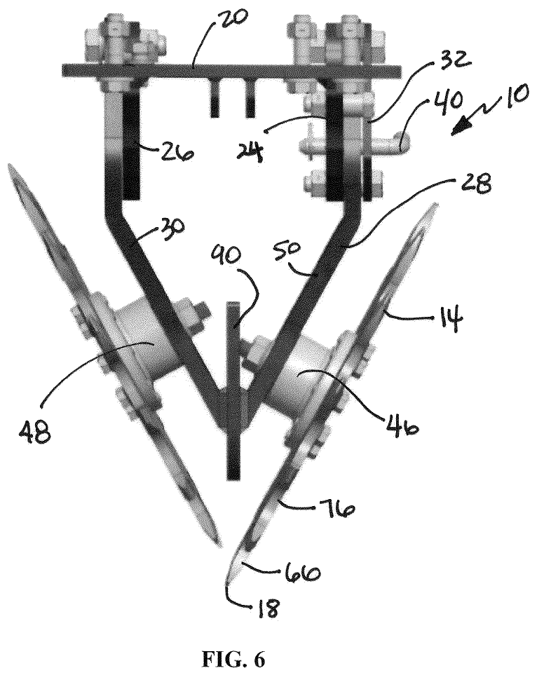

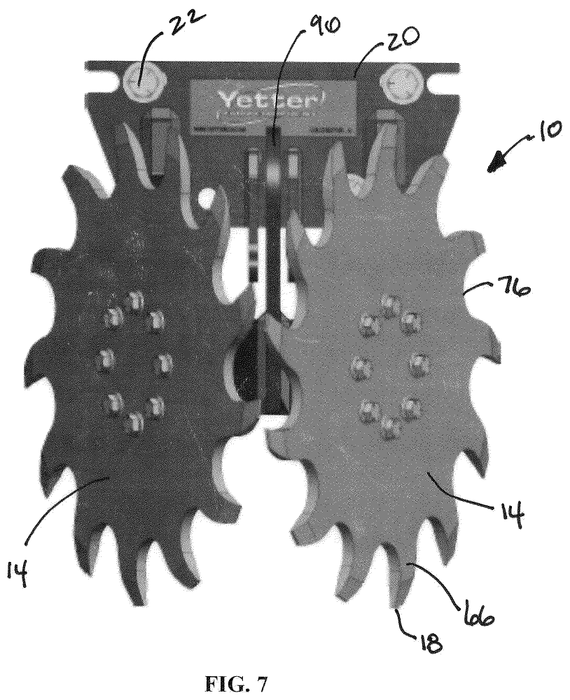

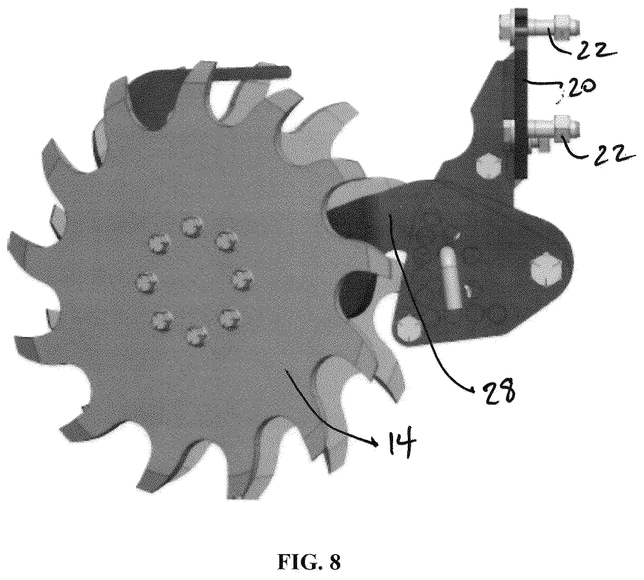

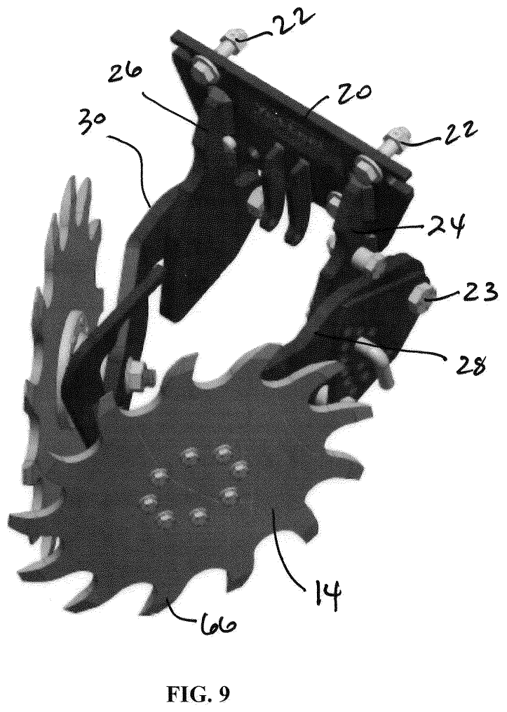

The first and second arms 28, 30 each include a top edge 50 and a spaced apart bottom edge 52, as shown in FIGS. 2 and 4. The first and second arms 28, 30 are angled inward such that the top edge 34 of the arms 28, 30 extend outwardly further than the bottom edge 36. The first and second arms 28, 30 are also angled inward toward one another such that the clearing discs 14, when mounted, have a toe-in orientation. The clearing discs 14 of the residue coulter 10, when attached to the first and second arms 28, 30, have an overall leading edge 54 that is positioned inward of the overall trailing edge 56 of the clearing discs 14 forming a toe-in configuration. The first and second arms 28, 30 each include a series of apertures 58 that are adapted to accept bolts 60 to secure clearing discs 14 to first and second hubs 46, 48, as shown in FIGS. 1-4. The clearing discs 14 also include an elongated aperture 62 that allows the clearing discs 14 to be properly indexed. Four of the bolts 60 are longer and include spacers 62 to allow the floater wheels 16 to be secured to the hubs 46, 48. Floater wheels 16 include indicator arrow so that floater wheels 16 can be properly indexed with clearing discs 14.

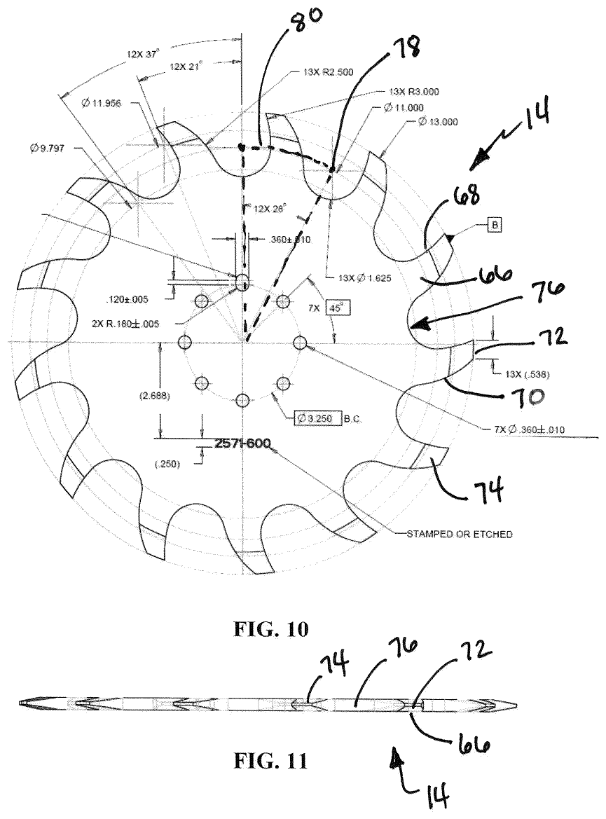

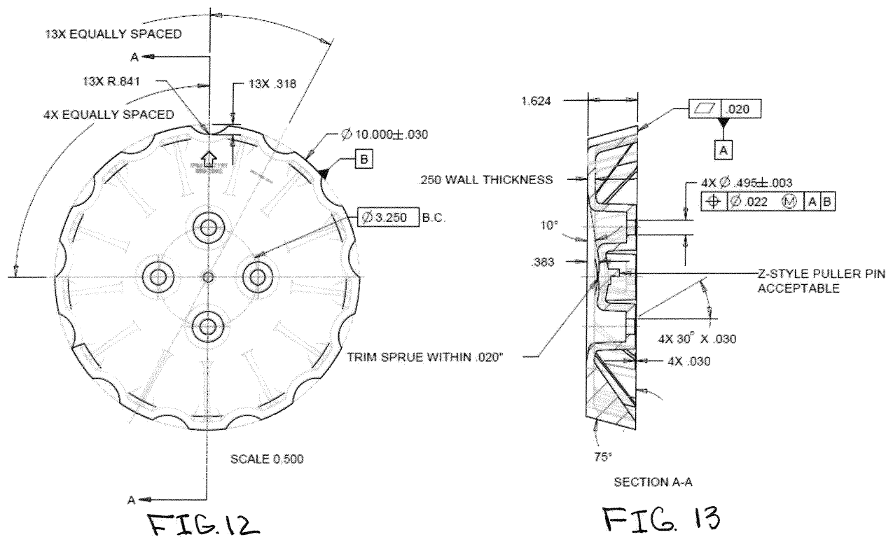

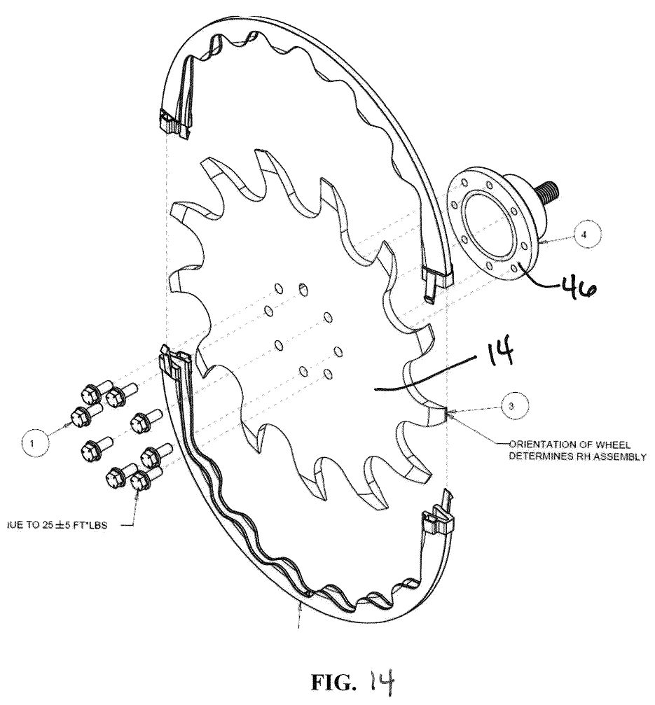

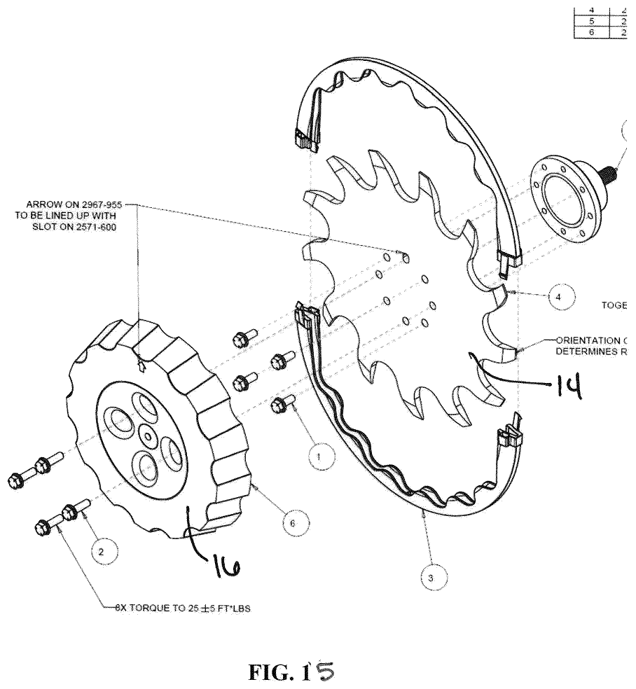

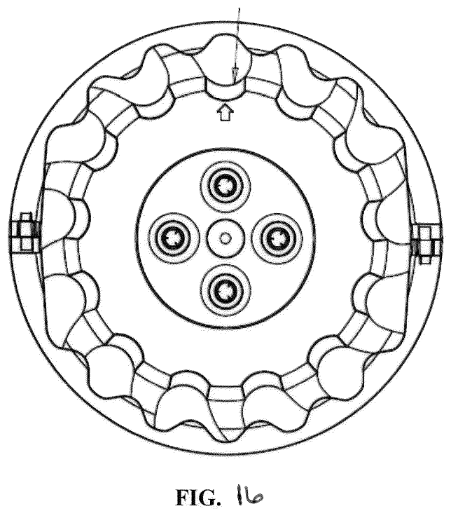

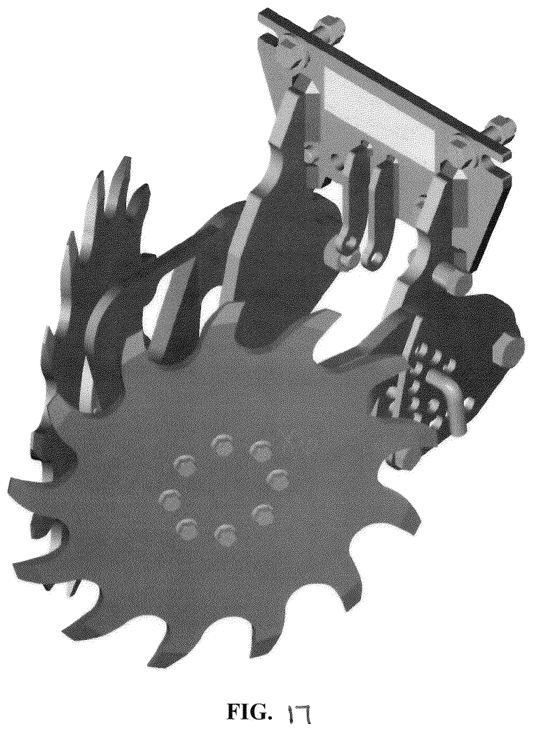

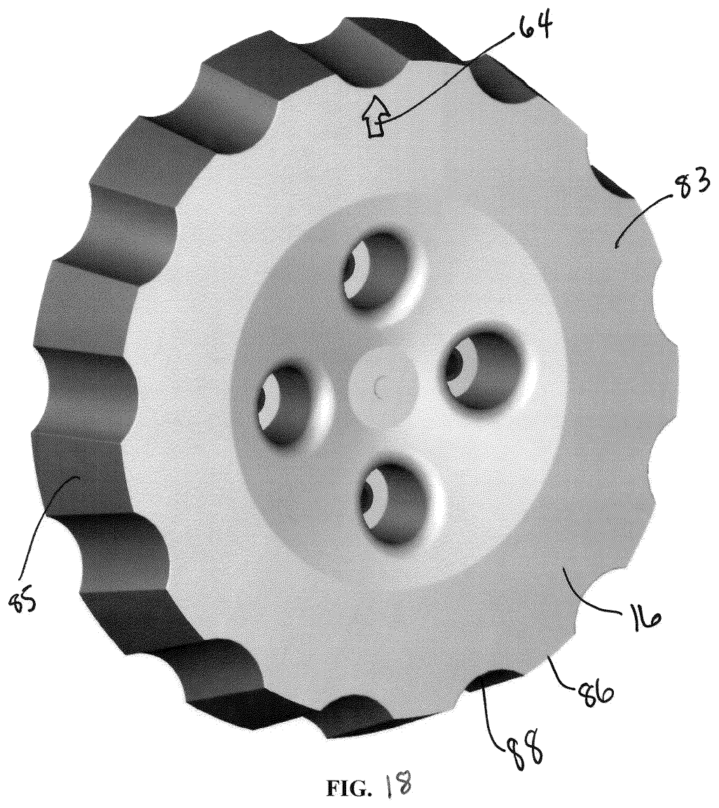

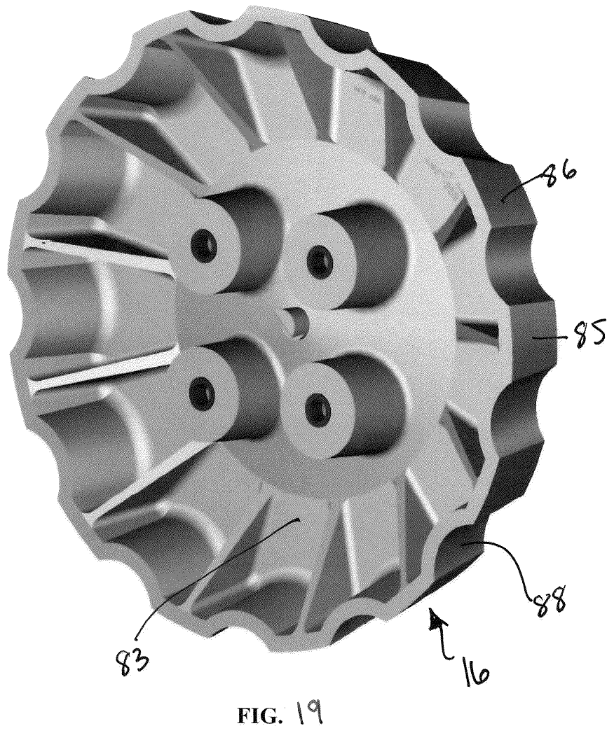

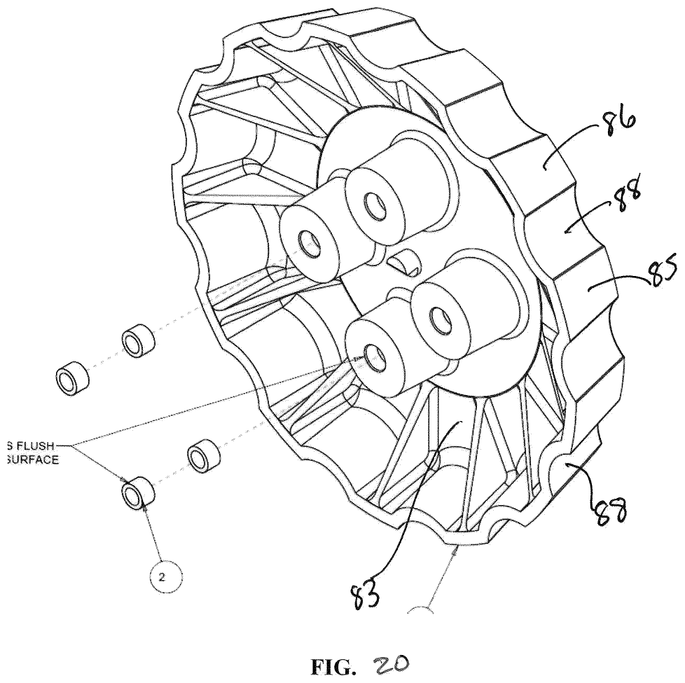

The clearing discs 14, as shown in FIGS. 10 and 11, lie in a substantially flat plane and define a plurality of backswept teeth 66 that surround the periphery of the clearing discs 14. The teeth 66 of the clearing discs 14 each include a curved leading edge 68, a curved trailing edge 70 and a linear cutting edge forming a crown 72, interconnecting the leading edge 68 to the trailing edge 70. As seen in, for example, FIG. 10 cutting edge 70 is substantially perpendicular to a radius of disc 14. The side surfaces of each tooth 66 include at least one beveled surface 74 to define cutting edge 70 on the top of teeth 66.

Teeth 66 are separated by recesses 76 located between teeth 66. The recesses 76 have a diameter from about 1.4 inches to 1.7 inches and preferably 1.625 inches from center point 78. The radius of the recesses 76 is about 0.8125 inches between the teeth. The arc 80 between center points 78 is from about 26 degrees to about 30 degrees and is preferably 28 degrees between center points 78. The use of large diameter recesses 76 between teeth 66 is to reduce or eliminate the likelihood of clumps of mud, rock or other debris becoming clogged between the teeth 66. Each clearing disc 14 includes between twelve and fourteen teeth and preferably includes thirteen teeth.

The clearing discs 14 having a diameter from about 12 inches to about 14 inches and is preferably 13 inches. The crown 72 of each tooth is from about 0.4 to about 0.6 inches in length and is preferably 0.536 inches in length. The short crown 72 with the large continuous radius between teeth 66 creates a narrow tooth profile. The continuous radius of curvature of the recess 76 extends from trailing edge of a first tooth 66 to the leading edge of an adjacent tooth 66. The teeth 66 are tapered from their base 84 to the crown 72 and are non-uniform in width. The transition from the leading and trailing edges 68, 70 to the crown 72 is a sharp angle and is not rounded. The narrow tooth profile with the large radius in the recesses 76 reduces the amount of soil displaced when compared with prior designs and reduces the amount of clogging of the clearing discs 14.

The cutting edge 48 is used to sever the crop residue. The backward slope of the teeth 42 in combination with the cutting edges 48 on each tooth 42 are used to grab, completely sever and relocate crop residue from the planting row. The tooth's engagement with the ground is nearly vertical with respect to the soil due to the overall orientation of the clearing discs 14. While it has been found that positioning the clearing discs 14 within ten degrees of vertical to be effective, broader angles may also be utilized and are within the scope of the present invention. The design of the teeth 66 permits one of the cutting edges 48 to be in contact with the soil surface at all times to cleanly cut residue with minimal soil disturbance, creating the ideal growing environment for optimum emergence in a variety of cropping practices.

Floater wheels 16 are adapted to be coupled to the clearing discs 14 by bolting floater wheels 16 to the hubs 46, 48. Floater wheels 16 include a side wall 83 and an annular skirt 85 that extends from the side wall 83. Floater wheels 16 include a series of tines 86 that are positioned around the skirt 85 of the floater wheel 16. The floater wheels 16 include from about 12 to 14 tines per wheel and preferably includes 13 tines per wheel. The amount of tines 86 matches the amount of teeth 66 on the clearing discs 14. So if the clearing disc 14 includes 13 teeth the floater wheel would include 13 tines. Tines 86 are separated by recesses 88. Floater wheels 16 include between 12 to 14 recesses per wheel and preferably includes 13 recesses per wheel to match the number of recesses 76 formed between the teeth 66 of clearing discs 14.

Floater wheels 16 are indexed with clearing discs 14 so that the tines 86 of the floater wheels 16 align with the teeth 66 of clearing discs 14 and the recesses 88 align with the recesses 76 formed in the clearing discs. Floater wheels 16 have a diameter from about 9 inches to about 11 inches and have a diameter preferably of 10 inches. The outermost diameter of the floater wheels 16 proximate the tines 86 terminates at the base 84 of the teeth 66 of the clearing discs 14. The width of the tines 86 are approximately the same width as the base 84 of the teeth 66. Further, the width of recesses 88 in the floater wheels 16 is approximate the same width as the recesses 76 of the clearing discs 14. The radius of the recesses 88 are continuous and have a radius from about 0.70 inches to about 0.90 inches and preferably a radius of 0.841 inches, which approximately matches the radius of the recesses 76 of clearing discs 14.

The skirt 85 of floater wheels 16 is tapered outward as the skirt 85 extends away from side wall 83. The taper of the skirt 85 of the floater wheels 16 is about 25 degrees. The floater wheel 16 has a thickness from about 1.5 to about 1.7 inches and preferably has a thickness of about 1.624 inches. Floater wheels 16 include indicia in the form of an indicator arrow 64 so that a user can properly align the floating wheels 16 with the clearing discs 14. This ensures that the tines 86 are properly aligned with the teeth 66 and the recesses of the floater wheels 16 are aligned with the recesses 76 of the clearing discs 14. This arrangement prevents any residue, rocks, mud, or other debris from becoming lodged within the recesses 76, 88 of the clearing discs 14 and floater wheels 16. This arrangement also properly controls the depth that the teeth 66 of the clearing discs 14 enter the soil as they sever and remove crop debris from the planting row.

The residue coulter 10 further includes a tie bar 90, best shown in FIG. 3 that is positioned adjacent to and between the clearing discs 14. The tie bar 90 is adapted to secure the first and second arms 28, 30 together by use of fasteners or by a more permanent means, such as welding. The tie bar 90 retains the orientation of the first and second arms 28, 30. As a means of deflection, a deflection rod 92 is used to deflect larger pieces of debris and prevent debris from re-entering the planting row. The deflection rod 92 also serves as a handle to permit the user to raise the clearing discs 14 when making height adjustments or removing debris stuck in the clearing discs 14.

The clearing discs 14 include apertures 42 that are positioned near the center of each clearing disc 14. The apertures 42 are adapted to permit the clearing discs 14 to be connected to the hubs 46, 48 of the residue coulter 10. The clearing discs 14 are designed to limit the relocation distance of the crop residue so that narrower seed row spacing can occur. Prior concave shaped clearing discs relocate debris at a distance great enough to create a thirty inch planting row whereas the flat clearing discs 14 of the present invention greatly reduce the debris relocation to less a quarter to a half of the other clearing discs. Actual relocation distances are also dependent partially upon ground speed of the planter. The clearing discs 14 are mounted ahead of depth gauge wheels that are used to control the placement of the clearing discs 14 with respect to the soil and maintain placement over uneven terrain. The clearing discs 14 are designed to be located closer to the gauge wheels of the planter unit 12 for improved depth control. Alternatively, discs 14 may be arranged at the rear of the unit for use as a trench closing device. The discs 14 are oriented in a toe-out configuration.

While the concepts of the present disclosure have been illustrated and described in detail in the drawings and foregoing description, such an illustration and description is to be considered as exemplary and not restrictive in character, it being understood that only the illustrative embodiments have been shown and described and that all changes and modifications that come within the spirit of the disclosure are desired and protected.

There are a plurality of advantages that may be inferred from the present disclosure arising from the various features of the apparatus, systems and methods described herein. It will be noted that alternative embodiments of each of the apparatus, systems, and methods of the present disclosure may not include all of the features described yet still benefit from at least some of the inferred advantages of such features. Those of ordinary skill in the art may readily devise their own implementations of an apparatus, system, and method that incorporate one or more of the features of the present disclosure and fall within the spirit and scope of the invention as defined by the appended claims.

What is claimed is:

1. A crop debris clearing device for severing and displacing crop debris from a planting row, the crop debris clearing system comprising:
a mounting plate used for mounting the clearing device;
first and second arms that are secured to the mounting plate;
first and second clearing disc that are rotatably connected to the first and second arms, the clearing discs being generally planar and formed to include a plurality of teeth that extend radially outwardly from the clearing discs, the teeth being configured to sever crop debris;
a plurality of recesses formed between the teeth of the clearing discs;
a first floater wheel positioned adjacent the first clearing disc and a second floater wheel positioned adjacent the second clearing disc, the floater wheels include a side wall and an annular skirt that extends from the side wall, the annular skirt including a plurality of tines separated by a plurality of recess wherein a majority of the tines align with a majority of the teeth of the clearing discs and the majority of the recesses of the annular skirt align with a majority of the recesses in the clearing discs.

2. The crop debris clearing device of claim 1, wherein the floater wheels are indexed with the clearing discs so that all of the tines of the floater wheels align with all of the teeth of the clearing discs.

3. The crop debris clearing device of claim 2, wherein all of the recesses of the floater wheels align with all of the recesses of the clearing discs.

4. The crop debris clearing device of claim 1, wherein the outermost extent of the tines terminate at a base of the teeth of the clearing discs.

5. The crop debris clearing device of claim 4, wherein the width of the tines are approximately the same width as the base of the teeth of the clearing discs.

6. The crop debris clearing device of claim 3, wherein the diameters of the recesses of the floater wheels is approximate the diameter of the recesses of the clearing discs.

7. The crop debris clearing device of claim 1, wherein the recesses of the floater wheels have a radius from about 0.70 inches to about 0.90 inches.

8. The crop clearing device of claim 1, wherein the floater wheels include indicia to allow indexing of the floating wheels with the clearing discs.

9. The crop debris clearing device of claim 1, wherein the clearing discs each include from about 12 to about 14 teeth per disc.

10. The crop debris clearing device of claim 9, wherein the floater wheels each include from about 12 to about 14 tines per wheel.

11. A crop debris clearing device for severing and displacing crop debris from a planting row, the crop debris clearing device comprising:
a generally planar clearing disc formed to include a plurality of teeth that are configured to extend radially outwardly from the clearing discs, the teeth being configured to sever crop debris;
a plurality of recesses formed between the teeth of the clearing disc;
a floater wheel positioned adjacent the clearing disc, the floater wheel including a side wall and an annular skirt that extends from the side wall, the annular skirt including a plurality of tines separated by a plurality of recess, wherein a majority of the tines align with a majority of the teeth of the clearing disc and the majority of the recesses in the annular skirt align with a majority of the recesses in the clearing disc.

12. The crop debris clearing device of claim 11, wherein the floater wheel is indexed with the clearing disc so that all of the tines of the floater wheel align with the teeth of the clearing disc.

13. The crop debris clearing device of claim 12, wherein all of the recesses of the floater wheel align with all of the recesses of the clearing disc.

14. The crop debris clearing device of claim 11, wherein the outermost extent of the tines terminate at a base of the teeth of the clearing disc.

15. The crop debris clearing device of claim 14, wherein the width of the tines are approximately the same width as the base of the teeth of the clearing disc.

16. The crop debris clearing device of claim 13, wherein the diameter of the recesses of the floater wheel are approximate the diameter of the recesses of the clearing disc.

17. The crop debris clearing device of claim 1, wherein the clearing disc includes from about 12 to about 14 teeth.

18. The crop debris clearing device of claim 17, wherein the floater wheel includes from about 12 to about 14 tines.

19. The crop clearing device of claim 11, wherein the floater wheels includes indicia to allow indexing of the floating wheel with the clearing disc.

20. A crop debris clearing device for severing and displacing crop debris from a planting row, the crop debris clearing system comprising:
a mounting plate used for mounting the clearing device;
a framed configured to be coupled to the mounting plate;
first and second clearing disc that are rotatably connected to the frame, the clearing discs being generally planar and formed to include a plurality of backswept teeth that extend radially outwardly from the clearing discs, the teeth being configured to sever crop debris, each tooth of the clearing disc formed to include a curved leading edge, a curved trailing edge and a crown interconnecting the leading edge to the trailing edge, the teeth being tapered from a base of the tooth to the crown and are non-uniform in width;
the clearing discs being formed to include recesses located between the teeth that form a continuous radius of curvature from a trailing edge of a first tooth to a leading edge of an adjacent tooth, wherein the teeth of the clearing discs are configured to sever crop debris and remove the debris from the planting row without the area between the teeth becoming clogged with soil.
